(19) United States
(12) Patent Application Publication
(10) Pub. No.: US 2026/0249937 A1
(43) Pub. Date: Aug. 27, 2026

(54) DETECTION SYSTEM, DETECTION METHOD, AND METHOD FOR MANUFACTURING MOBILE BODY

(71) Applicant: TOYOTA JIDOSHA KABUSHIKI KAISHA, Toyota-shi (JP)

(72) Inventors: Kento IWAHORI, Nagoya-shi (JP); Takuro SAWANO, Nisshin-shi (JP); Toshihiro KOIDE, Toyota-shi (JP); Yuhei NAGAFUCHI, Nagakute-shi (JP)

(73) Assignee: TOYOTA JIDOSHA KABUSHIKI KAISHA, Toyota-shi (JP)

(21) Appl. No.: 19/533,681

(22) Filed: Feb. 9, 2026

(30) Foreign Application Priority Data
Feb. 25, 2025 (JP) 2025-027931

(51) Int. Cl. B62D 65/00; B62D 65/18; G10K 11/178

(52) U.S. Cl. CPC B62D 65/005; B62D 65/18; G10K 11/17823; G10K 11/17873; G10K 2210/1282; G10K 2210/3027

(57) ABSTRACT

To provide a detection system, a detection method, and a method for manufacturing a mobile body each adapted to improve the detection accuracy of an anomalous sound. A detection system includes: a noise data acquisition unit, a canceling sound generation unit, a speaker control unit, a recorded data acquisition unit, and an anomalous sound detection unit. A noise data acquisition unit is configured to acquire noise data. A canceling sound generation unit is configured to generate, based on the noise data, a canceling sound. A speaker control unit is configured to control a speaker apparatus so as to reproduce the canceling sound. A recorded data acquisition unit is configured to acquire recorded data. An anomalous sound detection unit is configured to detect, from the recorded data, an anomalous sound.

### CROSS REFERENCE TO RELATED APPLICATIONS

This application is based upon and claims the benefit of priority from Japanese patent application No. 2025-027931, filed on February 25, 2025, the disclosure of which is incorporated herein in its entirety by reference.

### BACKGROUND

The present disclosure relates to a detection system, a detection method, and a method for manufacturing a mobile body.

Patent Literature 1 discloses a sound control method for a vehicle equipped with a noise canceling apparatus for reducing noise in a vehicle cabin. In the sound control method described in Patent Literature 1, it is determined whether or not a management-and-repair personnel involved in management or repair of a vehicle is included in the vehicle occupant. In the sound control method described in Patent Literature 1, in case where a management-and-repair personnel is included in the vehicle occupant, the noise reducing action of the noise canceling apparatus is stopped or reduced.

[Patent Literature 1] Japanese Unexamined Patent Application Publication No. 2023-173428

### SUMMARY

It should be noted that in carrying out the anomalous sound inspection of a mobile body, there is a possibility that the detection accuracy of the anomalous sound is degraded by the noise caused outside the mobile body. Therefore, in the case where the noise canceling function is reduced as in the technique described in Patent Literature 1, there is a possibility that the detection accuracy of the anomalous sound is degraded. That is, in the technique described in Patent Literature 1, there is a problem that the detection accuracy of the anomalous sound cannot be sufficiently improved.

The present disclosure is made in order to solve such a problem, and it is an object to provide a detection system, a detection method, and a method for manufacturing a mobile body each adapted to improve the detection accuracy of an anomalous sound.

A detection system according to the present disclosure includes: a noise data acquisition unit, a canceling sound generation unit, a speaker control unit, a recorded data acquisition unit, and an anomalous sound detection unit. The noise data acquisition unit is configured to acquire noise data related to noise outside a mobile body. The canceling sound generation unit is configured to generate, based on the noise data, a canceling sound for canceling the noise. The speaker control unit is configured to control a speaker apparatus so as to reproduce the canceling sound inside the mobile body. The recorded data acquisition unit is configured to acquire recorded data recorded inside the mobile body in which the canceling sound is reproduced. The anomalous sound detection unit is configured to detect, from the recorded data, an anomalous sound which is a sound associated with an abnormality of the mobile body.

According to the above-described configuration, the detection system according to the present disclosure can perform an anomalous sound inspection while suppressing the influence of noise originating outside a mobile body. As a result, the detection system according to the present disclosure can improve the detection accuracy of an anomalous sound.

In the detection system according to the present disclosure, the noise data acquisition unit may be configured to acquire the noise data from a recording apparatus installed outside the mobile body.

In the detection system according to the present disclosure, the speaker apparatus may be a speaker apparatus provided in the mobile body.

A detection method according to the present disclosure includes: acquiring noise data related to noise outside a mobile body; generating, based on the noise data, a canceling sound for canceling the noise; controlling a speaker apparatus so as to reproduce the canceling sound inside the mobile body; acquiring recorded data recorded inside the mobile body in which the canceling sound is reproduced; and detecting, from the recorded data, an anomalous sound which is a sound associated with an abnormality of the mobile body.

A method for manufacturing a mobile body includes: acquiring noise data related to noise outside a mobile body; generating, based on the noise data, a canceling sound for canceling the noise; controlling a speaker apparatus so as to reproduce the canceling sound inside the mobile body; acquiring recorded data recorded inside the mobile body in which the canceling sound is reproduced; detecting, from the recorded data, an anomalous sound which is a sound associated with an abnormality of the mobile body; and controlling the mobile body so as to travel to a predetermined position where the next manufacturing process is executed in the case where the anomalous sound is not detected from the recorded data.

According to the present disclosure, it is possible to provide a detection system, a detection method, and a method for manufacturing a mobile body each adapted to improve the detection accuracy of anomalous sound.

The above and other objects, features and advantages of the present disclosure will become more fully understood from the detailed description given hereinbelow and the accompanying drawings.

### BRIEF DESCRIPTION OF DRAWINGS

FIG. 1 is a schematic an overhead view showing a configuration of a mobile body control system according to a first embodiment;

FIG. 2 is a block diagram showing a configuration of a server according to the first embodiment;

FIG. 3 is a block diagram showing a configuration of the server according to the first embodiment; and

FIG. 4 is a flowchart showing an operation of the server according to the first embodiment.

### DESCRIPTION OF EMBODIMENTS

### First Embodiment

### Configuration of Detection System

Hereinafter, a first embodiment according to the present disclosure will be described in detail with reference to the drawings. First, a configuration of a detection system according to this embodiment will be described in detail.

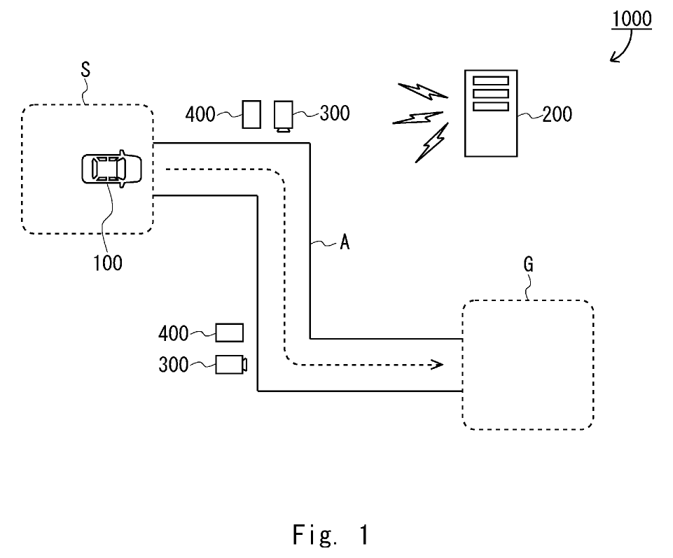

FIG. 1 is a schematic an overhead view showing a configuration of a mobile body control system according to the first embodiment. A detection system according to the first embodiment is implemented as a part of a mobile body control system 1000. The mobile body control system 1000 is configured to control the movement of mobile bodies. More specifically, the mobile body control system 1000 according to the first embodiment is configured to control the operation performed by a vehicle 100 shown in FIG. 1.

Note that in the present disclosure, the “mobile body” means an object that can move, and is, for example, a vehicle or an electric vertical take-off and landing aircraft (so-called a flying vehicle). The vehicle may be a vehicle that travels on wheels or by an endless track. For example, the vehicle is a passenger car, a truck, a bus, a two-wheeled vehicle, a four-wheeled vehicle, a tank, a construction vehicle, or the like. Examples of vehicles include a battery electric vehicle (BEV: Battery Electric Vehicle), a gasoline vehicle, a hybrid vehicle, and a fuel cell vehicle. When the mobile body is an object other than the vehicle, the terms “vehicle” or “car” in the present disclosure may be replaced with “mobile body” as appropriate, and the term “traveling” may be replaced with “moving” as appropriate.

The mobile body control system 1000 according to this embodiment controls the operation performed by the vehicle 100 shown in FIG. 1 to make the vehicle 100 move from a departure point S to a destination point G. More specifically, the mobile body control system 1000 according to this embodiment makes the vehicle 100 move from the departure point S to the destination point G by making the vehicle 100 travel in an area A.

The mobile body control system 1000 according to this embodiment may be introduced into a vehicle manufacturing factory, or may be used to control the movement of the vehicle 100 during manufacturing.

In this case, the departure point S and the destination point G according to this embodiment are workplaces for performing various manufacturing processes on the vehicle 100. In contrast to the departure point S, the destination point G may be referred to as a “predetermined position at which the next manufacturing process is executed”.

It should be noted that the “vehicle during manufacturing” as used herein may refer to a vehicle in a state where all assembly as a product is not completed, or a vehicle in a state where all assembly as a product is completed but inspection necessary for shipment is not completed.

The “manufacturing process” as used herein may include not only an assembly process and a processing process of vehicles, but also an inspection process after assembly is completed.

However, the application of the mobile body control system 1000 according to the present disclosure is not limited to the above. For example, the mobile body control system according to the present disclosure may be used to convey a plurality of vehicles manufactured in a vehicle manufacturing factory to a yard. Further, the mobile body control system according to the present disclosure may also be used to load a plurality of vehicles onto a ship or a freight train.

Although the details will be described later, the detection system according to this embodiment detects an anomalous sound which is a sound associated with an abnormality of the vehicle 100 at a timing when the vehicle 100 is moving in the area A. Here, the expression “detecting an anomalous sound” includes an attempt to detect an anomalous sound.

The mobile body control system 1000 may make the vehicle 100 move to the destination point G in the case where no anomalous sound is detected by the detection system according to this embodiment.

Further, the mobile body control system 1000 may make the vehicle 100 move to a point different from the destination point G in the case where the anomalous sound is detected by the detection system according to this embodiment. That is, the mobile body control system 1000 may change the destination point of the vehicle 100 in the case where the anomalous sound is detected at a timing when the vehicle 100 is made to move to the destination point G.

The mobile body control system 1000 according to this embodiment includes a server 200, an external sensor 300, and a recording apparatus 400.

In the mobile body control system 1000, the server 200 detects an anomalous sound generated in the vehicle 100. The server 200 acquires observation information of the area A from the external sensor 300 and detects position information of the vehicle 100 based on the observation information. The server 200 controls the operation performed by the vehicle 100 based on the detection result of the anomalous sound and the vehicle 100 position information.

That is, the detection system according to this embodiment is implemented as the server 200.

As described above, the detection system according to this embodiment is implemented as the server 200, i.e., a computer configured as a single apparatus. However, the configuration of the position detection system according to the present disclosure is not limited to the above, and may be configured of two or more apparatuses.

The external sensor 300 is a sensor located outside the vehicle 100. The external sensor 300 includes a communication apparatus and can communicate with other apparatuses such as the server 200 by wired communication or wireless communication. More specifically, the external sensor 300 according to this embodiment is a sensor for observing a movement region A in which mobile bodies move. The external sensor 300 transmits the observation information as the observation result of the movement region A to the server 200.

Specifically, the external sensor 300 is configured of a camera. The camera, which serves as the external sensor 300 takes a photograph image of the movement region A, and outputs the photograph image as observation information.

However, the external sensor 300 according to this embodiment is not limited to a camera, and may be, for example, a LiDAR (Light Detection And Ranging). In this case, the detection result output by the external sensor 300 may be three-dimensional point cloud data of the movement region A.

That is, the external sensor 300 according to this embodiment may be any sensor capable of outputting information usable for detecting position information of a vehicle by observing the movement region A.

The recording apparatus 400 is a recording apparatus located outside the vehicle 100. The recording apparatus 400 includes a communication apparatus, and can communicate with other apparatuses such as the server 200 by wired communication or wireless communication.

The recording apparatus 400 records noise outside a vehicle. The recording apparatus 400 outputs the recorded noise to the server 200 as noise data.

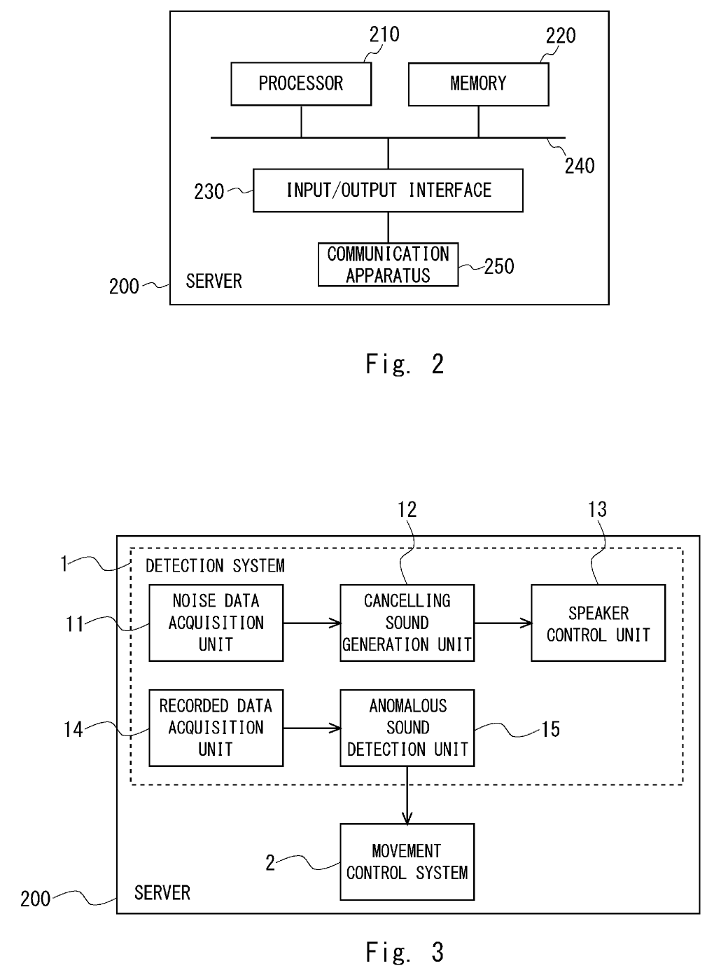

FIG. 2 is a block diagram showing a configuration of the server according to the first embodiment.

The server 200 is composed of a computer including a processor 210, a memory 220, an input/output interface 230, and an internal bus 240.

The processor 210, the memory 220, and the input/output interface 230 are bidirectionally connected to each other through the internal bus 240 so that they can communicate with each other.

A communication apparatus 250 for communicating with various apparatuses located outside the server 200 is connected to the input/output interface 230.

The communication apparatus 250 can communicate with the vehicle 100 by wireless communication, and can communicate with each external sensor 300 and each recording apparatus 400 by wired communication or by wireless communication. The processor 210 implements various functions including functions as a detection system 1 and a movement control system 2 by executing the programs stored in the memory 220.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The detection system 1 includes a noise data acquisition unit 11, a canceling sound generation unit 12, a speaker control unit 13, a recorded data acquisition unit 14, and an anomalous sound detection unit 15.

The noise data acquisition unit 11 acquires noise data from the recording apparatus 400 installed outside the vehicle 100. The noise data acquisition unit 11 outputs the acquired recorded data to the canceling sound generation unit 12. For example, the noise data acquisition unit 11 may acquire noise data as waveform data.

The canceling sound generation unit 12 acquires noise data from the noise data acquisition unit 11. The canceling sound generation unit 12 generates, based on the noise data, a canceling sound for canceling noise.

It should be noted that the canceling sound as used herein refers, for example, to a sound having an antiphase waveform with respect to a noise generated outside the vehicle 100.

The speaker control unit 13 controls the speaker apparatus so as to reproduce the canceling sound inside the vehicle 100. That is, the speaker control unit 13 controls the speaker apparatus so as to reproduce the canceling sound generated by the canceling sound generation unit 12.

By reproducing the canceling sound by the speaker apparatus, the influence of noise originating outside the vehicle 100 is suppressed inside the vehicle 100.

Note that the speaker apparatus according to this embodiment may be a speaker apparatus installed in the vehicle 100 or an apparatus independent of the vehicle 100.

In the case where the speaker apparatus according to this embodiment is a speaker apparatus installed in the vehicle 100, the server 200 transmits a control signal to a communication apparatus installed in the vehicle 100. Then, a control computer installed in the vehicle 100 controls the speaker apparatus to reproduce the canceling sound.

In the case where the speaker apparatus according to this embodiment is an apparatus independent of the vehicle 100, the server 200 transmits a control signal to the speaker apparatus. Then, a control computer installed in the speaker apparatus reproduces the canceling sound. In the case where the speaker apparatus according to this embodiment is an apparatus independent of the vehicle 100, the speaker apparatus may be installed inside the vehicle 100 by an operator at either the departure point S or the area A, for example. Then, after detection of the anomalous sound described later, it may be removed from the inside of the vehicle 100 by an operator.

The recorded data acquisition unit 14 acquires recorded data, which is data recorded inside the vehicle 100 in which the canceling sound is reproduced. The recorded data acquisition unit 14 outputs the acquired recorded data to the anomalous sound detection unit 15.

The recorded data acquisition unit 14 may acquire recorded data from, for example, a recording apparatus installed in the vehicle 100, or may acquire recorded data from a recording apparatus configured as an apparatus independent of the vehicle 100.

In the case where the recording apparatus according to this embodiment is a recording apparatus installed in the vehicle 100, the server 200 executes wireless communication with the vehicle 100 to acquire recorded data.

In the case where the speaker apparatus according to this embodiment is an apparatus independent of the vehicle 100, the server 200 executes wireless communication with the recording apparatus to acquire recorded data.

The anomalous sound detection unit 15 acquires recorded data from the recorded data acquisition unit 14. The anomalous sound detection unit 15 detects, from the recorded data, an anomalous sound which is a sound associated with an abnormality of a vehicle. The anomalous sound detection unit 15 outputs the detection result of the anomalous sound to the movement control system 2.

Note that as described above, the expression “detecting an anomalous sound” herein includes an attempt to detect an anomalous sound.

That is, the expression “detecting an anomalous sound” herein may refer to checking whether a sound corresponding to an anomalous sound is included in the acquired recorded data.

Note that the anomalous sound detection unit 15 according to this embodiment outputs the detection result of the anomalous sound to the movement control system 2, but the configuration of the anomalous sound detection system according to the present disclosure is not limited to this configuration. For example, the anomalous sound detection unit 15 according to the present disclosure may notify the user of the detection result of the anomalous sound.

The anomalous sound detection unit 15 according to this embodiment may be configured to output the detection result in the case where the anomalous sound is detected and may be configured not to output the detection result in the case where the anomalous sound is not detected, for example. The anomalous sound detection unit 15 according to this embodiment may output the detection result of both the case where the anomalous sound is detected and the case where the anomalous sound is not detected, for example.

That is, the anomalous sound detection unit 15 according to this embodiment may output a detection result at least in the case where an anomalous sound is detected.

As described above, the detection system 1 according to this embodiment reproduces, inside the vehicle 100, a canceling sound for a noise originating outside the vehicle 100. Then, the anomalous sound is detected from recorded data recorded within the vehicle 100 in which the canceling sound is reproduced.

According to such a configuration, the detection system 1 according to this embodiment can execute an anomalous sound inspection while suppressing an influence of a noise originating outside a vehicle. As a result, the detection system according to this embodiment can improve the detection accuracy of the anomalous sound.

The movement control system 2 acquires the detection result of the anomalous sound from the anomalous sound detection unit 15. The movement control system 2 controls the operation performed by the vehicle 100 based on the detection result of the anomalous sound.

More specifically, in the case where no anomalous sound is detected from the recorded data, the movement control system 2 makes the vehicle 100 move to the destination point G. In the case where an anomalous sound is detected from the recorded data, the movement control system 2 causes the vehicle 100 to perform an emergency operation.

It should be noted that an “emergency operation” herein refers to an operation for coping with the detected anomalous sound.

For example, an emergency operation may be an operation of stopping the vehicle 100 from traveling. Further, for example, an emergency operation may change the destination point of the vehicle 100 and make the vehicle 100 travel to the changed destination point. The changed destination point herein is, for example, a place where maintenance of the vehicle 100 is performed. In the changed destination point, it is preferable that the cause of the anomalous sound is identified in the vehicle 100 and that the identified cause of the anomalous sound is appropriately treated.

Hereinafter, a mode in which the movement control system 2 controls the operation of the vehicle 100 will be described in more detail. The movement control system 2 acquires observation information from the external sensor 300.

The movement control system 2 detects position information of mobile bodies based on the observation information. More specifically, the movement control system 2 detects the contour of a vehicle 100 from photograph image acquired as observation information, and calculates coordinates of the positioning point of the vehicle 100 in the coordinate system of the photograph image, i.e., the local coordinate system. The movement control system 2 converts the calculated local coordinates into coordinates in the global coordinate system, thereby detecting position information of the vehicle 100.

The contour of the vehicle 100 shown in the photograph image may be detected, for example, by inputting the photograph image into a detection model using artificial intelligence.

That is, the movement control system 2 according to this embodiment may detect position information of the vehicle 100 by inputting the acquired observation information to the artificial intelligence model which uses observation information as input information and outputs position information of the mobile body.

Examples of the detection model include, for example, a trained machine learning model that has been trained to implement either semantic segmentation or instance segmentation. As this machine learning model, for example, a convolutional neural network (hereinafter also referred to as a CNN) that has been trained by supervised learning using a learning data set may be used. The learning data set includes, for example, a plurality of training images including vehicles 100, and labels each of which indicates whether a respective area in training images is an area indicating a vehicle 100 or an area other than the vehicle 100. When the CNN is trained, parameters of the CNN are preferably updated so as to reduce errors between output results of the detection model and the labels by back-propagation (error back-propagation method). Further, the movement control system 2 may acquire the direction of the vehicle 100 by, for example, estimating it based on the direction of the movement vector of the vehicle 100 calculated from the positional changes of the feature points of the vehicle 100 between frames of the photograph image by using an optical flow method.

The movement control system 2 determines a destination position to which the vehicle 100 should travel next. The destination position is represented by, for example, coordinates of X, Y, and Z in the global coordinate system. In the movement control system 2, a reference route which is a route along which the vehicle 100 should travel is previously stored. The route is represented by a node representing a place of departure, a node representing a transit point, a node representing a final destination, and a link connecting the nodes. The movement control system 2 determines the destination position to which the vehicle 100 should travel next by using the vehicle position information and the reference route. The movement control system 2 determines the destination position on the reference route ahead of the current location of the vehicle 100.

The movement control system 2 generates a travel control signal for making the vehicle 100 travel toward the determined destination position. The movement control system 2 calculates the traveling speed of the vehicle 100 from the transition of the position of the vehicle 100, and compares the calculated traveling speed with the target speed.

The movement control system 2 determines acceleration so that the vehicle 100 accelerates in the case where the traveling speed is lower than the target speed as a whole, and determines acceleration so that the vehicle 100 decelerates in the case where the traveling speed is higher than the target speed.

The movement control system 2 determines the steering angle and the acceleration of the vehicle 100 so that the vehicle 100 does not deviate from the reference route in the case where the vehicle 100 is located on the reference route, and determines the steering angle and the acceleration so that the vehicle 100 returns on the reference route in the case where the vehicle 100 is not located on the reference route, that is, in the case where the vehicle 100 deviates from the reference route.

The movement control system 2 transmits the generated travel control signal to the vehicle 100. The movement control system 2 repeats acquisition of the position of the vehicle 100, determination of the destination position, generation of a travel control signal, transmission of the travel control signal, and the like at a predetermined cycle.

The vehicle 100 receives the travel control signal transmitted from the server 200. The vehicle 100 controls an actuator group by using the received travel control signal, thereby making the vehicle 100 travel at the acceleration and the steering angle represented by the travel control signal. The vehicle 100 repeats reception of the travel control signal and control of the actuator group at a predetermined cycle.

As described above, the detection system 1 according to this embodiment reproduces a canceling sound inside the vehicle 100 for noise originating outside the vehicle 100. Then, the detection system 1 according to this embodiment detects the anomalous sound from the recorded data recorded inside the vehicle 100 in which the canceling sound is reproduced.

According to this configuration, the detection system 1 according to this embodiment can execute the anomalous sound inspection while suppressing the influence of the noise originating outside a vehicle. As a result, the detection system 1 according to this embodiment can improve the detection accuracy of the anomalous sound.

### Manufacturing Method of Mobile Bodies

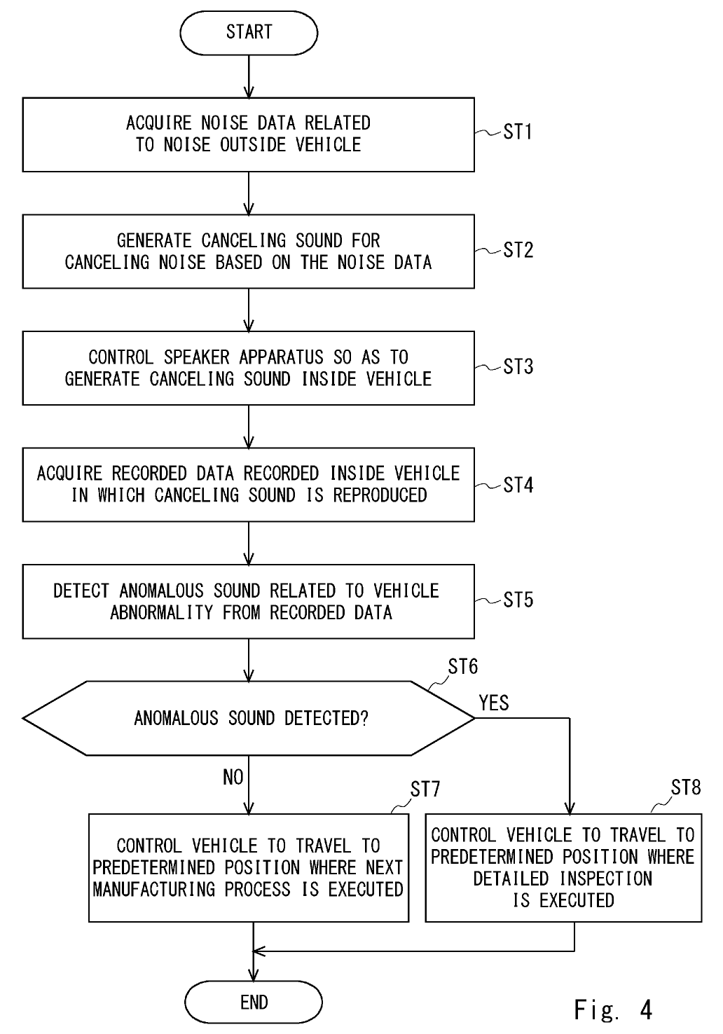

Next, a method for manufacturing mobile bodies according to the first embodiment will be described in detail. FIG. 4 is a flowchart showing an operation of the detection system according to the first embodiment. Note that in the following description, FIGS. 1 to 3 will be referred to as appropriate.

In the processing procedure of FIG. 4, the processor 210 of the server 200 functions as the detection system 1 and the movement control system 2 by reading out and executing a program stored in memory 220.

In the detection method according to this embodiment, first, the processor 210 acquires noise data related to noise outside a vehicle (Step ST1). That is, in Step ST1, the processor 210 functions as the noise data acquisition unit 11. More specifically, in Step ST1, the server 200 executes wire or wireless communication with the recording apparatus 400 to acquire noise data from the recording apparatus 400.

Next, the processor 210 generates, based on the noise data, a canceling sound for canceling the noise (Step ST2). That is, in Step ST2, the processor 210 functions as the canceling sound generation unit 12.

More specifically, in Step ST2, the server 200 generates a sound having an antiphase waveform with respect to a noise recorded in the noise data as a canceling sound.

Next, the processor 210 controls the speaker apparatus so as to generate the canceling sound inside a vehicle (Step ST3). That is, in Step ST3, the processor 210 functions as the speaker control unit 13.

By reproducing the canceling sound, the canceling sound and the noise are mutually canceled inside the vehicle 100. Therefore, by executing Step ST3, the noise originating outside the vehicle 100 is suppressed inside the vehicle 100.

Next, the processor 210 acquires recorded data recorded inside the vehicle 100 in which the canceling sound is reproduced (Step ST4). That is, in Step ST4, the processor 210 functions as the recorded data acquisition unit 14.

As described above, the noise originating outside the vehicle 100 is suppressed inside the vehicle 100 in which the canceling sound is reproduced. That is, in Step ST4, the server 200 acquires the recorded data recorded inside the vehicle 100 in a state in which the influence of the noise originating outside the vehicle 100 is suppressed.

Next, the processor 210 detects, from the recorded data, an anomalous sound which is a sound associated with an abnormality of a vehicle (Step ST5). That is, in Step ST5, the processor 210 functions as the anomalous sound detection unit 15.

Note that the operations from Step ST1 to Step ST5 may be referred to as detection method according to this embodiment.

As described above, the recorded data according to this embodiment is recorded inside the vehicle 100 in a state in which noise originating outside the vehicle 100 is suppressed. That is, in Step ST5, the anomalous sound of the vehicle 100 is detected from the recorded data in which the influence of noise originating outside the vehicle 100 is suppressed. With this configuration, the detection system according to this embodiment can improve the detection accuracy of the anomalous sound.

Next, in Step ST5, the processor 210 determines whether or not the anomalous sound is detected (Step ST6). That is, in Step ST6, the processor 210 functions as the movement control system 2.

In the case where no anomalous sound is detected (Step ST6 NO), the processor 210 controls the vehicle 100 to travel to a predetermined position where the next manufacturing process is executed (Step ST7), and the server 200 according to this embodiment ends a series of operations. That is, in Step ST7, the processor 210 functions as the movement control system 2.

More specifically, in Step ST7, the server 200 according to this embodiment controls the operation performed by the vehicle 100 so that the vehicle 100 travels to the destination point G.

In the case where an anomalous sound is detected (Step ST6 YES), the processor 210 controls the vehicle 100 to travel to a predetermined position where a detailed inspection is executed (Step ST8), and the server 200 according to this embodiment ends a series of operations. That is, in Step ST8, the processor 210 functions as the movement control system 2.

In other words, in Step ST7, the server 200 according to this embodiment changes destination point of the vehicle 100 and controls the vehicle 100 to travel to the changed destination point.

As described above, in the method for manufacturing mobile bodies according to this embodiment, the vehicle 100 is controlled based on the detection result of an anomalous sound. With this configuration, the method for manufacturing mobile bodies according to this embodiment can improve the quality of the manufactured vehicles 100.

As described above, in the detection method according to this embodiment, the anomalous sound inspection is performed while suppressing the influence of noise originating outside a vehicle. As a result, the detection method according to this embodiment can improve the detection accuracy of the anomalous sound.

Further, in the method for manufacturing mobile bodies according to this embodiment, a vehicle is made to move to either a predetermined position where the next manufacturing process is executed or a predetermined position where a detailed inspection is executed based on the detection result of the anomalous sound obtained by using the detection method described above. As a result, the method for manufacturing mobile bodies according to this embodiment can improve the quality of vehicles.

### Other Embodiments

### Other Embodiment 1

In the above-described first embodiment, the detection system 1 and the movement control system 2 are configured as a single computer apparatus, i.e., the server 200, but the configuration of the detection system according to the present disclosure is not limited to this example. For example, the detection system and the movement control system according to the present disclosure may be implemented as separate computer apparatuses.

In the detection system according to the present disclosure, a part of the functions may be implemented by a computer apparatus having a function as a mobile body control system, and other functions may be implemented by another computer apparatus.

For example, in the detection system according to the present disclosure, the functions of the noise data acquisition unit, the canceling sound generation unit, and the speaker control unit may be implemented by a vehicle control apparatus installed in the vehicle 100. In this case, the functions of the recorded data acquisition unit, the anomalous sound detection unit, and the movement control system 2 may be implemented by the server 200.

### Other Embodiment 2

In the above-described first embodiment, the server 200 performs processes from acquiring the vehicle position information to generating a travel control signal. In contrast, at least some of the processes from acquiring the vehicle position information to generating a travel control signal may be performed by the vehicle 100. For example, Forms (1) to (3) described below may be adopted.

(1) The server 200 may detect position information of the vehicle 100, determine a destination position to which the vehicle 100 should travel next, and generate a route from the current location of the vehicle 100 indicated in the detected vehicle position information to the destination position. The server 200 may generate a route to an intermediate destination position located between the current location and the final destination, or a route to the final destination. The server 200 may transmit the generated route to the vehicle 100. The vehicle 100 may generate a travel control signal so as to travel on the route received from the server 200, and control the actuator group by using the generated travel control signal.

(2) The server 200 may detect position information of the vehicle 100 and transmit the detected vehicle position information to the vehicle 100. The vehicle 100 may determine a destination position to which the vehicle 100 should travel next, generate a route from the current location of the vehicle 100 indicated in the received vehicle position information to the destination position, generate a travel control signal so as to travel on the generated route, and control the actuator group using the generated travel control signal.

(3) In the above-described Forms (1) and (2), the vehicle 100 may include an internal sensor mounted thereon, and a detection result output from the internal sensor may be used for at least one of the generation of a route and the generation of a travel control signal. The internal sensor is a sensor mounted on the vehicle 100. Examples of internal sensors may include a sensor for detecting a motion state of the vehicle 100, a sensor for detecting an operation state of each part of the vehicle 100, and a sensor for detecting an environment around the vehicle 100. Specifically, examples of internal sensors may include a camera, a LiDAR, a millimeter-wave radar, an ultrasonic sensor, a GPS sensor, an acceleration sensor, and a gyroscopic sensor. For example, in the above-described Form (1), the server 200 may acquire a detection result of the internal sensor and take the acquired detection result of the internal sensor into consideration for a route in generating a route. In the above-described Form (1), the vehicle 100 may acquire a detection result of the internal sensor and take the acquired detection result of the internal sensor into consideration for a travel control signal in generating a travel control signal. In the above-described Form (2), the vehicle 100 may acquire a detection result of the internal sensor and take the acquired detection result into consideration for a route in generating a route. In the above-described Form (2), the vehicle 100 may acquire a detection result of the internal sensor and take the acquired detection result of the internal sensor into consideration for a travel control signal in generating a travel control signal.

### Other Embodiment 3

In the above-described first embodiment, the vehicle 100 may include an internal sensor mounted thereon. Further, the vehicle control apparatus may acquire a detection result of the internal sensor, detect current position information of the vehicle 100 based on the acquired detection result, and output a control parameter(s) based on the detected current position information. That is, the position detection system according to the present disclosure may be a system installed in a vehicle 100.

### Other Embodiment 4

In the above-described first embodiment, a control parameter(s) may be output based on both the detection result of the internal sensor described in Other Embodiment 3 and the detection result of the external sensor described in Other Embodiment 3.

### Note

Transporting the vehicle 100 by using the traveling of the vehicle 100 by unmanned driving is also referred to as “self-propelled conveyance”. A configuration for realizing self-propelled conveyance is also referred to as a “vehicle remote control autonomous conveyance system”. A production method of producing the vehicle 100 by using self-propelled conveyance is also referred to as “self-propelled production”. In self-propelled production, for example, at least a part of conveyance of the vehicle 100 is realized by self-propelled conveyance in a factory FC that manufactures the vehicle 100.

While the present disclosure has been described with reference to the above-described embodiments, the present disclosure is not limited to the configuration of the above-described embodiments, and various changes, modifications, or combinations may be made by a person skilled in the art within the scope of the claimed disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A detection system comprising:
a noise data acquisition unit configured to acquire noise data related to noise outside a mobile body;
a canceling sound generation unit configured to generate, based on the noise data, a canceling sound for canceling the noise;
a speaker control unit configured to control a speaker apparatus so as to reproduce the canceling sound inside the mobile body;
a recorded data acquisition unit configured to acquire recorded data recorded inside the mobile body in which the canceling sound is reproduced; and
an anomalous sound detection unit configured to detect, from the recorded data, an anomalous sound which is a sound associated with an abnormality of the mobile body.

2. The detection system according to claim 1, wherein the noise data acquisition unit is configured to acquire the noise data from a recording apparatus installed outside the mobile body.

3. The detection system according to claim 1, wherein the speaker apparatus is a speaker apparatus provided in the mobile body.

4. A detection method comprising:
acquiring noise data related to noise outside a mobile body;
generating, based on the noise data, a canceling sound for canceling the noise;
controlling a speaker apparatus so as to reproduce the canceling sound inside the mobile body;
acquiring recorded data recorded inside the mobile body in which the canceling sound is reproduced; and
detecting, from the recorded data, an anomalous sound which is a sound associated with an abnormality of the mobile body.

5. A method for manufacturing a mobile body, comprising:
acquiring noise data related to noise outside a mobile body;
generating, based on the noise data, a canceling sound for canceling the noise;
controlling a speaker apparatus so as to reproduce the canceling sound inside the mobile body;
acquiring recorded data recorded inside the mobile body in which the canceling sound is reproduced;
detecting, from the recorded data, an anomalous sound which is a sound associated with an abnormality of the mobile body; and
controlling the mobile body so as to travel to a predetermined position where the next manufacturing process is executed in the case where the anomalous sound is not detected from the recorded data.
